(19) United States
(12) Patent Application Publication
(10) Pub. No.: US 2003/0172235 A1
(43) Pub. Date: Sep. 11, 2003

(54) Read data storage controller with bypass read data return path

(76) Inventors: George Thomas Letey, Boulder, CO (US); Jeffrey G. Hargis, Fort Collins, CO (US); Michael Kennard Tayler, Loveland, CO (US); Erin Antony Handgen, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/375,625

(22) Filed: Feb. 27, 2003

Related U.S. Application Data
(60) Provisional application No. 60/360,346, filed on Feb. 27, 2002.

(51) Int. Cl. G06F 12/00

(52) U.S. Cl. 711/138; 711/154

(57) ABSTRACT

In accordance with an embodiment of the present invention, a system for returning data comprises a storage array operable to store data received from at least one data source, a bypass circuit communicatively coupled with the storage array and operable to simultaneously stage data received from the at least one data source and a read data storage controller communicatively coupled with the storage array and the bypass circuit and operable to select a data return path of minimum latency from a plurality of data return paths for returning data selected from one of the storage array and the bypass circuit, based at least in part on at least one tag associated with each of the at least one data source, to a requesting device.

### RELATED APPLICATIONS

This patent application claims the benefit of Provisional Patent Application Serial No. 60/360,346, entitled Synchronizing Controller and Bypass Mechanism for Read Data Return Path, filed on Feb. 27, 2002, the disclosure of which is incorporated herein by reference. This patent application is related to co-pending U.S. patent application Ser. No. 09/827,766, entitled “Memory Controller with Support for Memory Modules Comprised of Non-Homogeneous Data Width RAM Devices,” filed Apr. 7, 2001, co-pending U.S. patent application, Ser. No. 10/189,839, entitled “System and Method for Multi-Modal Memory Controller System Operation,” filed Jul. 5, 2002, and co-pending U.S. patent application, Ser. No. 10/189,825, entitled “Method and System for Optimizing Pre-Fetch Memory Transactions,” filed Jul. 5, 2002, the disclosures of which are incorporated herein by reference.

### TECHNICAL FIELD OF THE INVENTION

The present invention relates generally to the field of computer memory systems, and more particularly to a read data storage controller with bypass read data return path.

### BACKGROUND OF THE INVENTION

A memory controller processes memory access requests, such as requests to read data from and write data to memory modules. A memory access request may be initiated by a requesting device, such as a central processing unit (CPU) or an input/output (I/O) device. A desirable property of memory controllers is returning read data from memory with minimum latency.

Computers require fast access to portions of computer memory to enable timely execution of instructions that are stored in memory. However, because data received from the memory modules may be out-of-order, determining the validity of particular data received from the memory modules increases the latency in returning data to the requesting device.

### SUMMARY OF THE INVENTION

In accordance with an embodiment of the present invention, a system for returning data comprises a storage array operable to store data received from at least one data source, a bypass circuit communicatively coupled with the storage array and operable to simultaneously stage data received from the at least one data source and a read data storage controller communicatively coupled with the storage array and the bypass circuit and operable to select a data return path of minimum latency from a plurality of data return paths for returning data selected from one of the storage array and the bypass circuit, based at least in part on at least one tag associated with each of the at least one data source, to a requesting device.

In accordance with another embodiment of the present invention, a method for returning data comprises receiving a request for data from a requesting device, receiving data from at least one data source, storing the received data in a storage array, simultaneously staging the received data in a bypass circuit, selecting a data return path of minimum latency from a plurality of data return paths for returning the data and providing data from one of the storage array and the bypass circuit to the requesting device via the selected data return path of minimum latency based at least in part on at least one tag associated with each of the at least one data source.

In accordance with another embodiment of the present invention, a system for returning data comprises means for storing the data received from at least one data source, means for simultaneously staging the data received from the at least one data source, means for selecting a data return path of minimum latency from a plurality of data return paths for returning the data and means for providing data to a requesting device from one of the means for storing and the means for simultaneously staging via the selected data return path of minimum latency based at least in part on at least one tag associated with each of the at least one data source.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a high-level block diagram of a memory control system comprising a Read Data Storage in accordance with an embodiment of the present invention;

FIGS. 2A and 2B illustrate a more detailed circuit diagram of the Read Data Storage of FIG. 1 in accordance with an embodiment of the present invention;

FIGS. 3A-3D illustrate a detailed circuit diagram of a bypass circuit in accordance with an embodiment of the present invention;

FIG. 4 is a state transition diagram for a Write Control Finite State Machine in accordance with an embodiment of the present invention;

FIG. 5 is a state transition diagram for an Address Control and Bypass Finite State Machine in accordance with an embodiment of the present invention; and

FIG. 6 is a state transition diagram for a Data Advance Finite State Machine in accordance with an embodiment of the present invention.

### DETAILED DESCRIPTION OF THE DRAWINGS

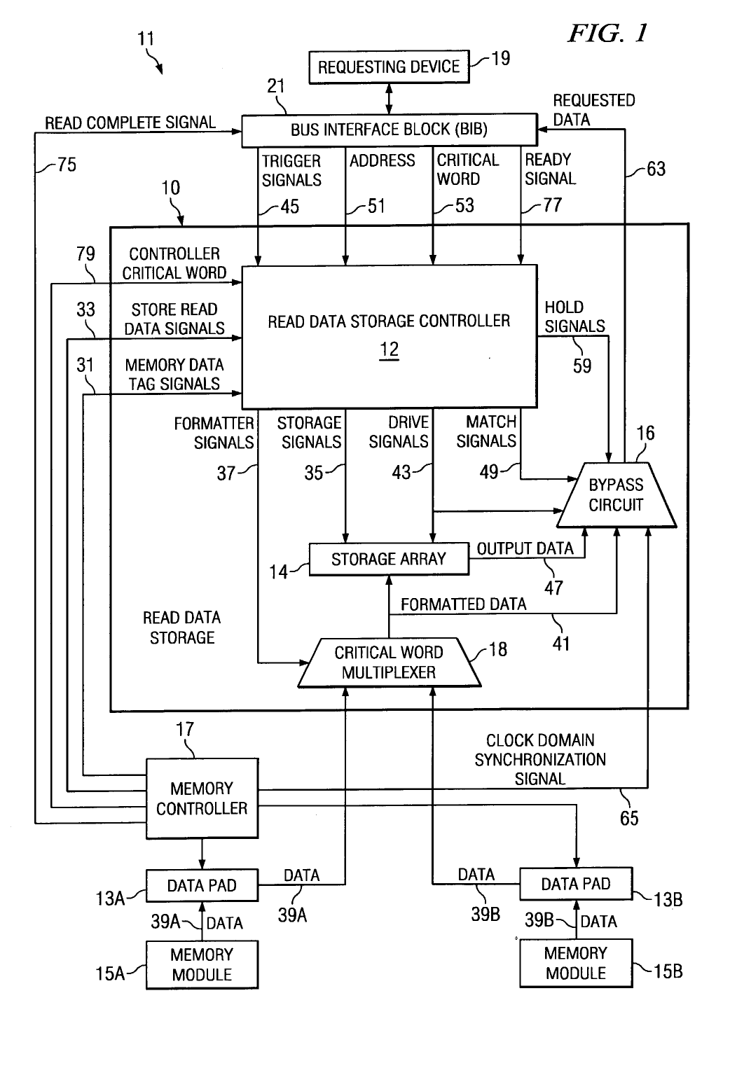

The preferred embodiment of the present invention and its advantages are best understood by referring to FIGS. 1 through 6 of the drawings, like numerals being used for like and corresponding parts of the various drawings.

There is a desire for a system and method for returning data from memory with minimum latency. Accordingly, in accordance with an embodiment of the present invention, a read data storage controller is provided which determines the best path for returning data to a requesting device such that the data is provided to the requesting device with minimum latency. Preferably, a tagging mechanism is used to minimize latency in returning data. A source with valid data is determined and the data returned through a path that results in minimum latency. In order to provide the data with minimum latency, a plurality of fast storage locations are used so that a large storage area, which would otherwise increase the latency, may be bypassed.

FIG. 1 is a high-level block diagram of a memory control system 11 comprising a Read Data Storage (RDS) 10 in accordance with an embodiment of the present invention. RDS 10 may be communicatively coupled with a requesting device 19, for example a processor, via a Bus Interface Block (BIB) 21. If desired, BIB 21 may itself be the requesting device or be part of the requesting device. Furthermore, if desired, the requesting device may be part of BIB 21.

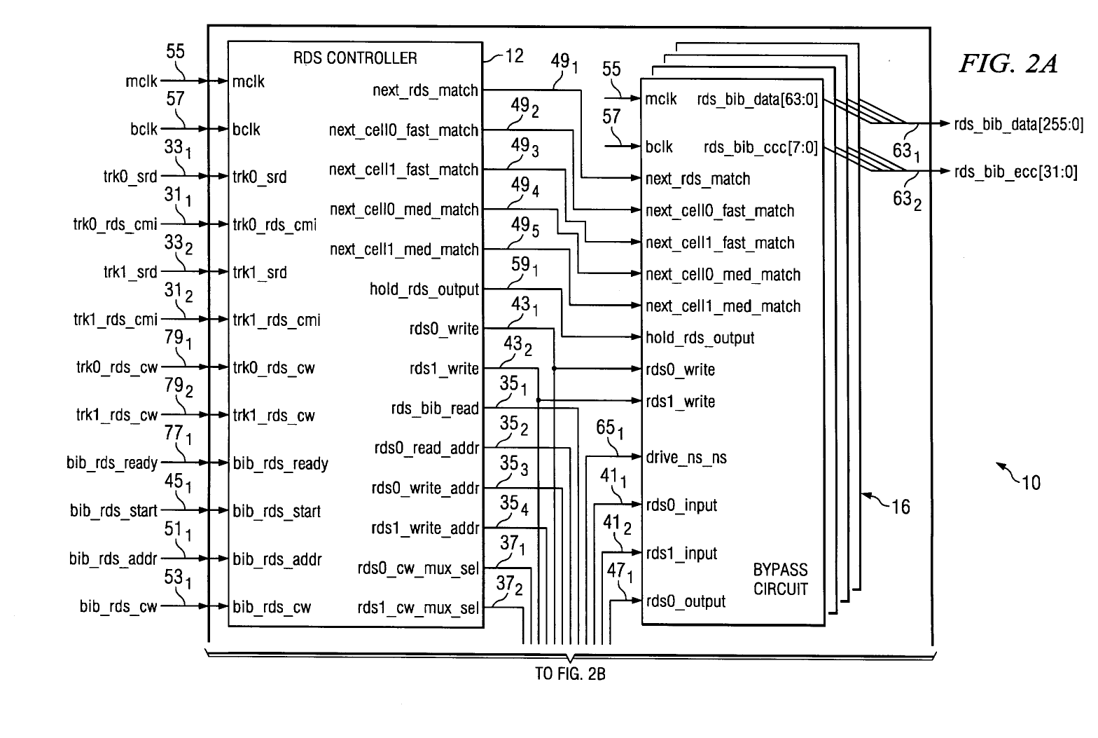

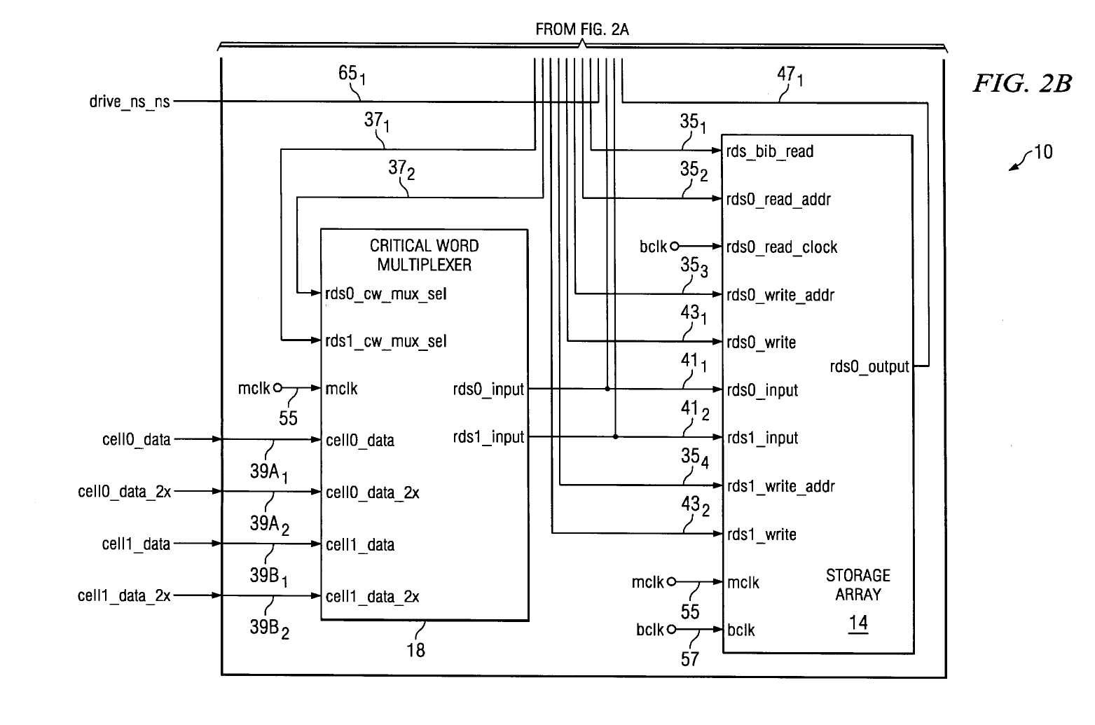

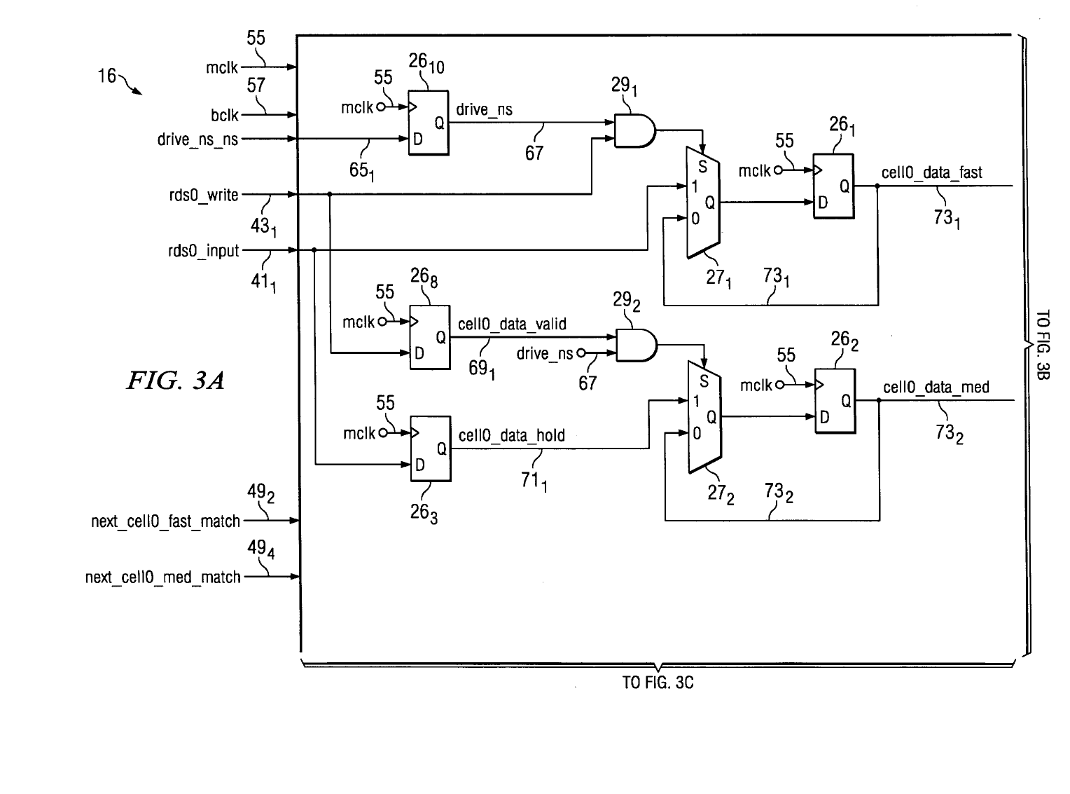

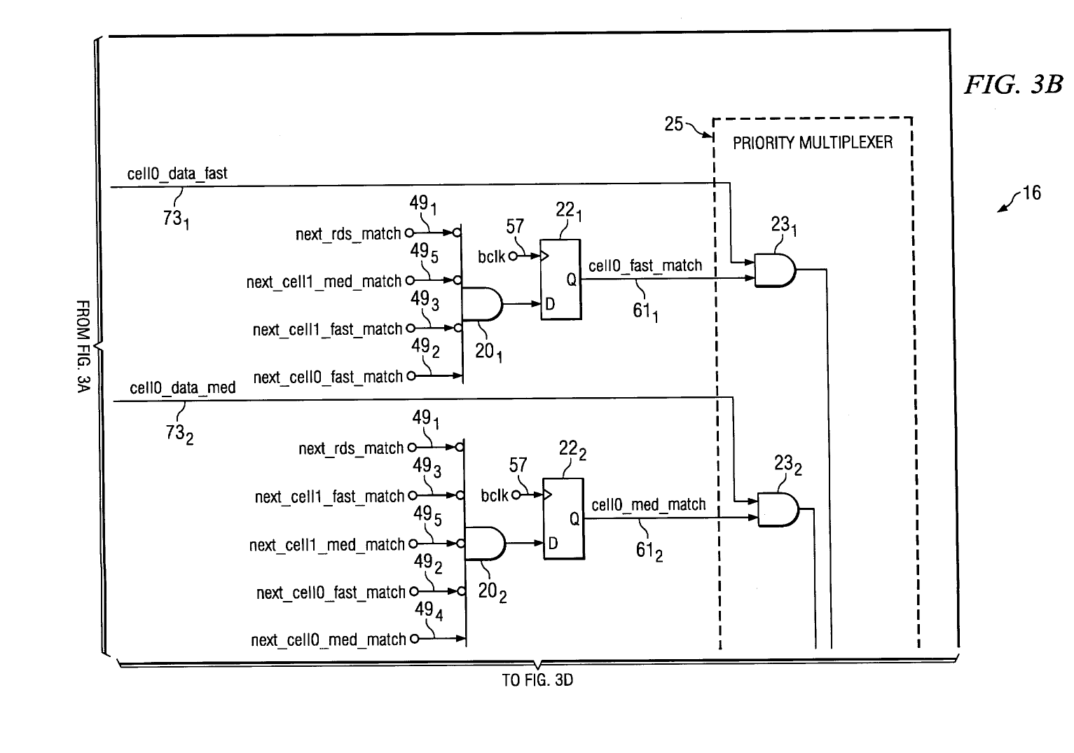

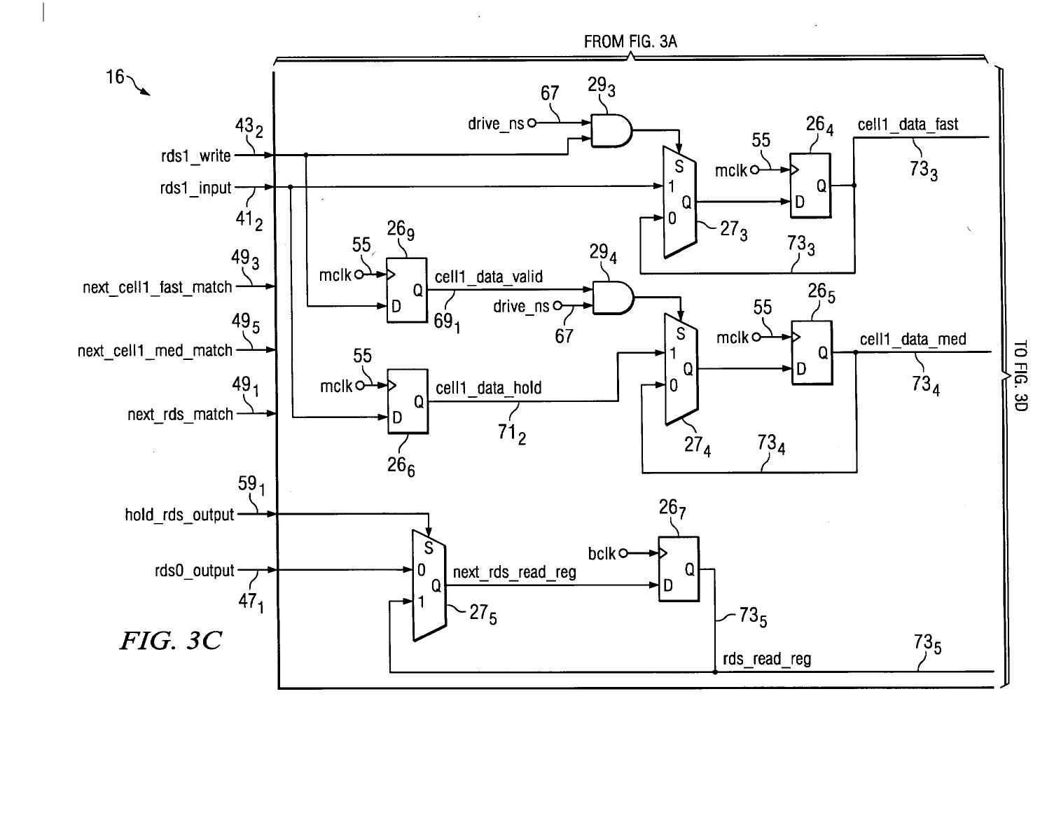

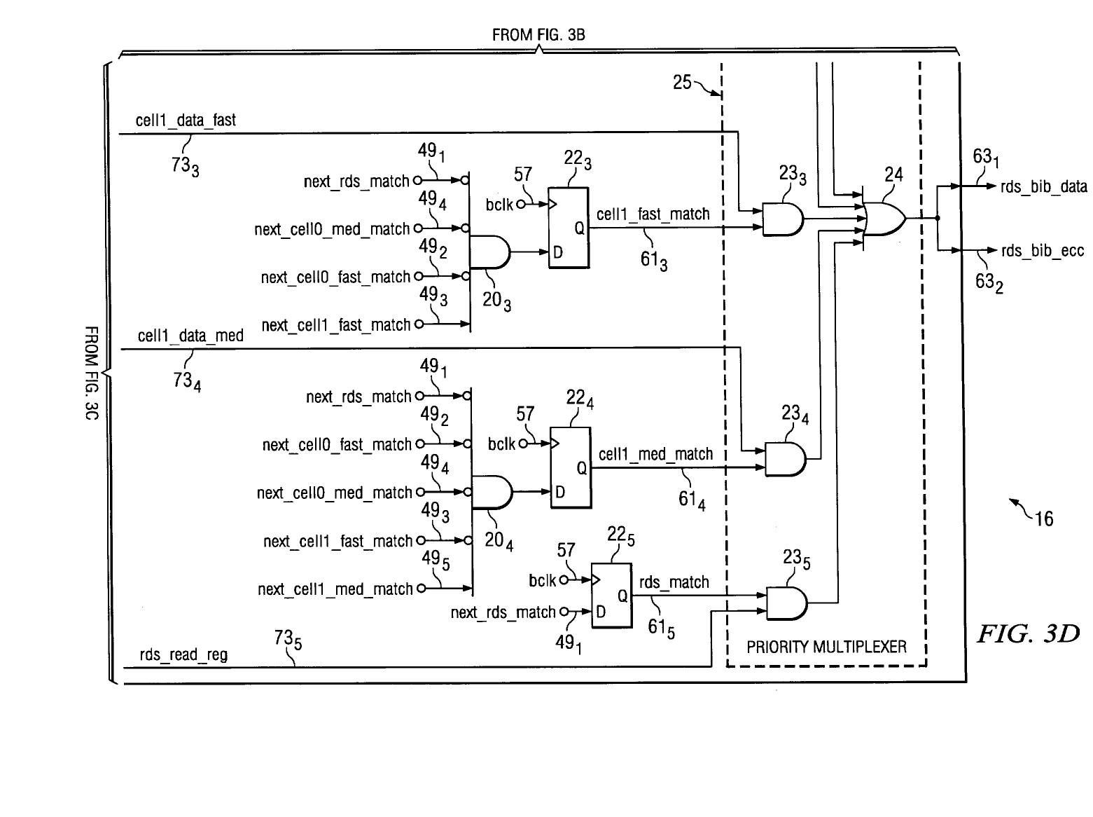

BIB 21 may be communicatively coupled with memory controller 17. Memory controller 17 and BIB 21 may be operating in separate clock domains as denoted in FIGS. 2 and 3 by mclk 55 for the memory controller and bclk 57 for the BIB. Memory controller 17 may be communicatively coupled with one or more data pads 13A and 13B and also with RDS 10. An input of data pad 13A may be coupled with an output of memory module 15A and an input of data pad 13B may be coupled with an output of memory module 15B.

RDS 10 comprises a RDS controller 12 which is communicatively coupled with a storage array 14 and a bypass circuit 16. RDS 10 also preferably comprises a critical word multiplexer 18. The inputs of critical word multiplexer 18 are coupled to an output of one or more of data pads 13A and 13B and to an output of RDS controller 12. The output of critical word multiplexer 18 is coupled to an input of storage array 14 and an input of bypass circuit 16. The output of storage array 14 is communicatively coupled to an input of bypass circuit 16, the output of which is in turn communicatively coupled to an input of BIB 21.

Storage array 14 preferably comprises a plurality of storage cells. In an exemplary embodiment, storage array 14 is a 288×128 storage array with 128 cells, each cell being 288 bits wide. Storage array 14 is designed to store thirty-two cache lines addressable in ¼ cache line portions, for a total of 128 288-bit wide storage locations. A cache line is the minimum size data set that a requesting device may request. RDS controller 12 incorporates a data valid vector (not shown) that provides information to one or more finite state machines associated with RDS controller 12 to indicate which cells of storage array 14 contain valid data at any given time.

In operation, memory controller 17 informs BIB 21 via a read complete signal 75 that a particular read transaction will be completed in a predetermined number of clock cycles. Upon receipt of read complete signal 75, BIB 21 asserts a trigger signal 45 which is provided to RDS controller 12. Along with trigger signal 45, RDS controller 12 also receives an address 51 and a critical word 53 from BIB 21 specifying the data requested by BIB 21. When BIB 21 is ready to receive data from RDS 10, it asserts a ready signal 77 informing RDS controller 12 that it is ready to receive data to be forwarded to requesting device 19.

RDS controller 12 receives memory data tag signals 31 and store read data signals 33 from memory controller 17. Memory data tag signals 31 track memory read and write transactions and their associated data. Store read data signals 33, when active, instruct RDS controller 12 that data will be valid at one of the corresponding data pads 13A and 13B on a succeeding clock. The assertion of one or more of the store read data signals indicates that even if data in storage array 14 or bypass circuit 16 may have been valid at some point, it is no longer valid and should be overwritten. As such, the data valid vector may be cleared in response to receiving one or more of the store read data signals 33. RDS controller also receives controller critical word 79 from memory controller 17.

Critical word multiplexer 18 receives data (39A, 39B) from one or more of the memory modules 15A and 15B via data pads 13A and 13B respectively. The width of data (39A and 39B) received from the data pads may vary depending on the operating mode of RDS controller 12. As such, critical word multiplexer 18 may queue the data so that data of a valid or acceptable width may be provided to BIB 21. Furthermore, depending on the mode of operation of RDS controller 12, the data may be received from the data pads at different clock intervals. Thus, data may be received every clock cycle or every other clock cycle.

Upon receipt of memory data tag signals 31 and store read data signals 33, RDS controller 12 asserts one or more storage signals 35 and/or one or more formatter signals 37, based at least in part on the operating mode of RDS controller 12. Storage signals 35 are provided to storage array 14 and are used to control read and write operations to storage array 14. Formatter signals 37 are provided to critical word multiplexer 18 and instruct critical word multiplexer 18 to format data 39A and data 39B received from data pads 13A and 13B respectively into the appropriate word order as requested by requesting device 19.

If requested by RDS controller 12, critical word multiplexer 18 formats the data into an appropriate format. Under the control of RDS controller 12, data 41 from critical word multiplexer 18 is provided to storage array 14 and/or to bypass circuit 16. In the exemplary embodiment, formatted data 41 is preferably 288 bits wide.

RDS controller 12 may also generate and provide drive signals 43 to storage array 14 and bypass circuit 16 to inform them that the data arriving from data pads 13A and 13B via critical word multiplexer 18 is valid in the current clock cycle. Output data 47 from storage array 14 may be routed to bypass circuit 16. RDS controller 12 may also generate and provide hold signals 59 to bypass circuit 16. Hold signals 59 instruct bypass circuit 16 to hold output data 47 received from storage array 14.

Since data may be stored in multiple locations, it may be valid in different locations in different clock cycles. Furthermore, data may be received from multiple sets of data pads simultaneously, whereas BIB 21 may be requesting data from only one set of data pads. RDS controller 12 not only provides information on when the data is valid but also coordinates input data from multiple sets of data pads so that incoming data not currently requested by BIB 21 may be stored for future transfer to BIB 21. A tagging mechanism may be used to ensure that the proper data is returned to BIB 21. Address 51 and critical word 53 received from BIB 21 may comprise of a plurality of bits. The bits of address 51 and critical word 53 are combined to create a first tag associated with the data requested by BIB 21. Memory data tag signals 31 and controller critical word 79 are combined to build tags associated with the data received from data pads 13A and 13B. This tag is used to track the flow and current location of data in RDS 10.

The first tag is compared with the tag of the data that is received from data pads 13A and 13B and/or data that has previously been received from data pads 13A and 13B. The tags are matched to determine where the data is valid and to ensure that the correct data word is sent to BIB 21. If the two tags match, then there may be a bypass opportunity and data from bypass circuit 16 may be provided to BIB 21. If the tags do not match, the data in storage array 14 may be valid. By referencing bits in the data valid vector corresponding to the first tag, a determination may be made as to whether the data in storage array 14 is valid. If the data in storage array 14 is valid, then it may be provided to BIB 21 via bypass circuit 16.

In conventional systems, once data is written into a storage element, it may not be possible to return the data to the BIB for two or three cycles. This increases the latency in conventional systems.

In RDS 10, however, it is possible to return data to BIB 21 without waiting for two or three cycles. One or more of the match signals 49 may be asserted as a match by RDS controller 12. If there is no valid data, then none of the match signals 49 may be asserted as a match. Match signals 49 are provided to bypass circuit 16. Depending on the match signal asserted, data may be returned to BIB 21 in less than three cycles. By using a tagging mechanism to determine when the data is valid where, data integrity is maintained and latency in providing the data to BIB 21 may be reduced.

The tagging mechanism facilitates determination of where the data is valid so that it may be returned in the fastest time possible, thereby reducing the latency. The logic, which is preferably implemented in the form of one or more finite state machines, causes at most one of the above match signals 49 to select the data to be transmitted to BIB 21. The match signals determine which data will be transferred to BIB 21. In an exemplary embodiment, requested data 63 provided to BIB 21 is 256 bits wide and the corresponding error correction code is 32 bits wide.

FIGS. 2A and 2B illustrate a more detailed circuit diagram of RDS 10 in accordance with an embodiment of the present invention. Table I specifies the relationship between the relevant signals of FIG. 1 and the corresponding signals of FIGS. 2A and 2B in a table format. In Table I, the signals are classified based on whether they are inputs or outputs to RDS controller 12, bypass circuit 16, storage array 14 and critical word multiplexer 18. When relevant, details on these signals are provided hereinbelow with reference to FIGS. 3A-3D.

TABLE 1

FIGS. 2A and 2B

INPUTS TO RDS CONTROLLER

| | |
|---|---|
| Ready signal 77 | bib_rds_ready 77₁ |
| Store read data signals 33 | trk0_srd 33₁ |
| | trk1_srd 33₂ |
| Memory data tag signals 31 | trk0_rds_cmi 31₁ |
| | trkl_rds_cmi 31₂ |
| Trigger signal 45 | bib_rds_start 45₁ |
| Address 51 | bib_rds_addr 51₁ |
| Critical word 53 | bib_rds_cw 53₁ |
| Controller critical word 79 | trk0_rds_cw 79₁ |
| | trk1_rds_cw 79₂ |

OUTPUTS FROM RDS CONTROLLER

| | |
|---|---|
| Formatter signals 37 | rds0_cw_mux_sel 37₁ |
| | rds1_cw_mux_sel 37₂ |
| Storage signals 35 | rds_bib_read 35₁ |
| | rds0_read_addr 35₂ |
| | rds0_write_addr 35₃ |
| | rds1_write_addr 35₄ |
| Drive signals 43 | rds0_write 43₁ |
| | rds1_write 43₂ |
| Hold signals 59 | hold_rds_output 59₁ |
| Match signals 49 | next_rds_match 49₁ |
| | next_cell0_fast_match 49₂ |
| | next_cell1_fast_match 49₃ |
| | next_cell0_medium_match 49₄ |
| | next_cell1_medium_match 49₅ |

INPUTS TO BYPASS CIRCUIT

| | |
|---|---|
| Match signals 49 | next_rds_match 49₁ |
| | next_cell0_fast_match 49₂ |
| | next_cell1_fast_match 49₃ |
| | next_cell0_medium_match 49₄ |
| | next_cell1_medium_match 49₅ |
| Drive signals 43 | rds0_write 43₁ |
| | rds1_write 43₂ |
| Hold signals 59 | hold_rds_output 59₁ |
| Formatted data 41 | rds0_input 41₁ |
| | rds1_input 41₂ |
| Output data 47 | rds0_output 47₁ |
| Clock domain synchronization signal 65 | drive_ns_ns 65₁ |

OUTPUTS FROM BYPASS CIRCUIT

| | |
|---|---|
| Requested data 63 | rds_bib_data 63₁ |
| | rds_bib_ecc 63₂ |

INPUTS TO STORAGE ARRAY

| | |
|---|---|
| Drive signals 43 | rds0_write 43₁ |
| | rds1_write 43₂ |
| Formatted data 41 | rds0_input 41₁ |
| | rds1_input 41₂ |
| Storage signals 35 | rds_bib_read 35₁ |
| | rds0_read_addr 35₂ |
| | rds0_write_addr 35₃ |
| | rds1_write_address 35₄ |

OUTPUTS FROM STORAGE ARRAY

| | |
|---|---|
| Output data 47 | rds0_output 47₁ |

INPUTS TO CRITICAL WORD MULTIPLEXER

| | |
|---|---|
| Data from data pads 39A, 39B | cell0_data 39A₁ |
| | cell0_data_2x 39A₂ |
| | cell1_data 39B₁ |
| | cell1_data 2x 39B₂ |
| Formatter signals 37 | rds0_cw_mux_sel 37₁ |
| | rds1_cw_mux_sel 37₂ |

OUTPUTS FROM CRITICAL WORD MULTIPLEXER

| | |
|---|---|
| Formatted data 41 | rds0_input 41₁ |
| | rds1_input 41₂ |

FIGS. 3A-3D illustrate a detailed circuit diagram of bypass circuit 16 in accordance with an embodiment of the present invention. Bypass circuit 16 acts as a staging area for data. Bypass circuit 16 comprises a priority multiplexer 25. Priority multiplexer 25 preferably comprises an OR gate 24. The output of OR gate 24 is coupled to an input of BIB 21 (FIG. 1). Priority multiplexer 25 preferably also comprises a plurality of gates 23, such as gates 23₁, 23₂, 23₃, 23₄, and 23₅, each gate 23 preferably coupled with OR gate 24.

Bypass circuit 16 also comprises a plurality of timing registers 22, such as timing registers 22₁, 22₂, 22₃, 22₄, and 22₅. Preferably, the output of each timing register 22 is communicatively coupled with an input of at least one of the gates 23. In the illustrated embodiment of FIGS. 3A-3D, the output timing register 22₁ is communicatively coupled with an input of AND gate 23₁, the output of timing register 22₂ is communicatively coupled with an input of AND gate 23₂, the output of timing register 22₃ is communicatively coupled with an input of AND gate 23₃, the output of timing register 22₄ is communicatively coupled with an input of AND gate 23₄ and the output of timing register 22₅ is communicatively coupled with an input of AND gate 23₅.

Preferably, bypass circuit 16 also comprises a plurality of gates 20, such as gates 20₁, 20₂, 20₃, and 20₄, the output of each gate 20 preferably communicatively coupled with an input of at least one of the timing registers 22. In the illustrated embodiment of FIGS. 3A-3D, the output of gate 20₁ is communicatively coupled with an input of timing register 22₁, the output of gate 20₂ is communicatively coupled with an input of timing register 22₂, the output of gate 20₃ is communicatively coupled with an input of timing register 22₃, and the output of gate 20₄ is communicatively coupled with an input of timing register 22₄. Each of the gates 20₁ through 20₄ is preferably an AND gate.

Bypass circuit 16 also preferably comprises at least one fast staging register, at least one medium staging register, and at least one regular staging register, for example fast staging registers 26₁ and 26₄, medium staging registers 26₂ and 26₅, and regular staging register 26₇. Each of the fast, medium and regular staging registers is communicatively coupled between priority multiplexer 25 and a synchronization multiplexer, for example synchronization multiplexers 27₁ through 27₅. In the illustrated embodiment of FIGS. 3A-3D, fast staging register 26₁ is communicatively coupled between synchronization multiplexer 27₁ and AND gate 23₁, medium staging register 26₂ is communicatively coupled between synchronization multiplexer 27₂ and AND gate 23₂, fast staging register 26₄ is communicatively coupled between synchronization multiplexer 27₃ and AND gate 23₃, medium staging register 26₅ is communicatively coupled between synchronization multiplexer 27₄ and AND gate 23₄, and regular staging register 26₇ is communicatively coupled between synchronization multiplexer 27₅ and AND gate 23₅.

Bypass circuit 16 also preferably comprises a plurality of gates 29, such as gates. 29₁, 29₂, 29₃, and 29₄, each of the gates 29₁ through 29₄ preferably communicatively coupled between a next state register 26₁₀ and at least one of the synchronization multiplexers 27₁ through 27₄. In the illustrated embodiment of FIGS. 3A-3D, gate 29₁, is communicatively coupled between synchronization multiplexer 27₁ and next state register 26₁₀, gate 29₂ is communicatively coupled between synchronization multiplexer 27₂ and next state register 26₁₀, gate 29₃ is communicatively coupled between synchronization multiplexer 27₃ and next state register 26₁₀, and gate 29₄ is communicatively coupled between synchronization multiplexer 27₄ and next state register 26₁₀. Each of the gates 29₁ through 29₄ is preferably an AND gate.

An input of each of the synchronization multiplexers 27₂ and 27₄ is communicatively coupled with an output of data hold register. In the illustrated embodiment of FIGS. 3A-3D, an input of synchronization multiplexer 27₂ is communicatively coupled with an output of a data hold register 26₃ and an input of synchronization multiplexer 27₄ is communicatively coupled with an output of a data hold register 26₆. An input of each of the AND gates 29₂ and 29₄ is communicatively coupled with an output of a data valid register. In the illustrated embodiment of FIGS. 3A-3D, an input of AND gate 29₂ is communicatively coupled with an output of a data valid register 26₈ and an input of AND gate 29₄ is communicatively coupled with an output of a data valid register 26_{9.}

Next state register 26₁₀ receives mclk 55 and a clock domain synchronization signal 65 (FIG. 1), for example drive_ns_ns signal 65₁, from memory controller 17. Clock domain synchronization signal 65 informs bypass circuit 16 when data may be driven from registers which operate in the mclk domain, for example registers 26₁ through 26₇ to registers which operate in the bclk domain, for example timing registers 22. Preferably, clock domain synchronization signal 65 is two clocks advanced, i.e. the second clock from when clock domain synchronization signal 65 becomes valid will be a valid clock for driving data from registers which operate in the mclk domain to registers that operate in the bclk domain.

The output of next state register 26₁₀ is a next state signal. In FIGS. 3A-3D, the next state signal is denoted as drive_ns signal 67. Preferably, drive_ns signal 67 is provided as an input to each of the gates 29. Gate 29₁ also receives as input rds0_write signal 43₁ from RDS controller 12, which indicates that data rds0_input 41₁ arriving from the data pads is valid in the current clock cycle. Gate 29₃ also receives as input rds1_write signal 43₂ from RDS controller 12, which indicates that data rds1_input 41₂ arriving from the data pads is valid in the current clock cycle. If the data is valid and drive_ns signal 67 is valid, then data rds0_input 41₁ may be forwarded to fast staging register 26₁ via synchronizing multiplexer 27₁ and/or data rds1_input 41₂ may be forwarded to fast staging register 26₄ via synchronizing multiplexer 27₃.

Data hold register 26₃ receives as input mclk 55 and data rds0_input 41₁ from critical word multiplexer 18. Data hold register 26₃ holds the data prior to providing it to medium staging register 26₂ via synchronizing multiplexer 27₂ as cell0_data_hold 71₁. Data valid register 268 receives as input mclk 55 and rds0_write signal 43₁ from RDS controller 12. The output signal, cell0_data_valid signal 69₁, of data valid register 26₈ is provided to gate 29₂ along with drive_ns signal 67. The output of gate 29₂ informs synchronizing multiplexer 27₂ when the data in the associated data hold register 26₃ is valid.

Data hold register 26₆ receives as input mclk 55 and data rds1_input 41₂ from critical word multiplexer 18. Data hold register 26₆ holds the data prior to providing it to medium staging register 26₅ via synchronizing multiplexer 27₄ as cell1_data_hold 71₂. Data valid register 26₉ receives as input mclk 55 and rds1 write signal 43₂ from RDS controller 12. The output signal, cell1_data_valid signal 69₂, of data valid register 26₉ is provided to gate 29₄ along with drive_ns signal 67. The output of gate 29₄ informs synchronizing multiplexer 27₄ when the data in the associated data hold register 26₆ is valid.

Synchronizing multiplexer 27₅ receives as input hold_rds_output signal 59₁ from RDS controller 12 and data rds0_output 47, from storage array 14. The output of synchronizing multiplexer 27₅ is provided as an input to regular staging register 26₇ along with bclk 57 and the output of regular staging register 26₇ is provided as input to gate 23₅ of priority multiplexer 25.

The output of each of the staging registers 26₁, 26₂, 26₄, 26₅, and 26₇ is preferably provided to priority multiplexer 25 and also fed back as input to the associated synchronization multiplexers 27₁ through 27₅. In the illustrated embodiment of FIGS. 3A-3D, the output, cell0_data_fast 73₁, of fast staging register 26₁ is provided to gate 23₁ and fed back as input to synchronization multiplexer 27₁; the output, cell0_data_med 73₂, of medium staging register 26₂ is provided to gate 23₂ and fed back as input to synchronization multiplexer 27₂; the output, cell1_data_fast 73₃, of fast staging register 26₄ is provided to gate 23₃ and fed back as input to synchronization multiplexer 27₃; the output, cell1_data_med 73₄, of medium staging register 26₅ is provided to gate 23₄ and fed back as input to synchronization multiplexer 27₄; and the output, rds_read_reg 73₅, of fast staging register 26₇ is provided to gate 23₅ and fed back as input to synchronization multiplexer 27₅.

Fast staging register 26₁ along with its associated synchronization multiplexer 27₁ provides a fast bypass for data rds0_input 41₁ from data pad 13A; medium staging register 26₂ and data hold register 26₃ form a cascaded pair and along with associated synchronization multiplexer 27₂ provide a medium bypass for data rds0_input 41, from data pad 13A; fast staging register 26₄ along with its associated synchronization multiplexer 27₃ provides a fast bypass for data rds1_input 41₂ from data pad 13B; medium staging register 26₅ and data hold register 26₆ form a cascaded pair and along with associated synchronization multiplexer 27₄ provide a medium bypass for data rds1_input 41₂ from data pad 13B. Data rds0_output 47₁ from storage array 14 is staged in regular staging register 26₇. By cascading multiple ¼ cache line sized registers, such as registers 26₁ through 26₇, multiple data sources of varying latencies are created.

Each of the gates 20₁ through 20₄ receives at least one match signal 49 from RDS controller 12. For example, in the illustrated embodiment of FIGS. 3A-3D, gate 20₁ receives the complement of next_rds_match signal 49₁, the complement of next_cell1_medium_match signal 49₅, the complement of next_cell1_fast_match signal 49₃, and next_cell0_fast_match signal 49₂ from RDS controller 12; gate 20₂ receives the complement of next_rds_match signal 49₁, the complement of next_cell1_fast_match signal 49₃, the complement of next_cell1_medium_match signal 49₅, the complement of next_cell0_fast_match signal 49₂, and next_cell0_medium_match signal 49₄ from RDS controller 12; gate 20₃ receives the complement of next_rds_match signal 49₁, the complement of next_cell0_medium_match signal 49₄, the complement of next_cell0_fast_match signal 49₂, and next_cell1_fast_match signal 49₃ from RDS controller 12; and gate 20₄ receives the complement of next_rds_match signal 49₁, the complement of next_cell0_fast_match signal 49₂, the complement of next_cell0_medium_match signal 49₄, the complement of next_cell1_fast_match signal 49₃, and the complement of next_cell1_medium_match signal 49₅ from RDS controller 12.

When next_cell0_fast_match signal 49₂ and/or next_cell1_fast_match signal 49₃ is asserted, it indicates that the data received in the last cycle from the data pads should be returned to BIB 21. When next_cell0_medium_match signal 49₄ and/or next_cell1_medium_match signal 49₅ is asserted, it indicates that the data received two cycles ago should be returned to BIB 21. When next_rds_match signal 49₁ is asserted, it indicates that the data received in a cycle that was three or more cycles ago should be returned to BIB 21.

The various match signals are ANDed at the corresponding gates 20 and the output of gates 20 provided to the associated timing registers 22 in such a way that the output of at most one of the corresponding timing registers 22₁ through 22₄ or the output of timing register 22₅ will be asserted at any time during a data return operation. If the output of timing register 22₁ is asserted, then data from rds0_input 41₁ is returned through a fast bypass; if the output of timing register 22₂ is asserted, then data from rds0_input 41₁ is returned through a medium bypass; if the output of timing register 22₃ is asserted, then data from rds1_input 41₂ is returned through a fast bypass; if the output of timing register 22₄ is asserted, then data from rds1_input 41₂ is returned through a medium bypass; and if the output of timing register 22₅ is asserted, then data from rds0_output 47₁ is returned. Timing registers 22 ensure that the match signals are correctly associated in time with the associated bypass paths. The outputs of gates 20 are registered in the corresponding timing registers 22 so that they correspond with the associated data on the correct bclk 57 clock edge.

The output of each timing register 22 is preferably a match control signal which is provided to the corresponding AND gate 23. For example, the output of timing register 22₁ is cell0_fast_match signal 61₁ which is provided to gate 23₁, the output of timing register 22₂ is cell0_med_match signal 61₂ which is provided to gate 23₂, the output of timing register 22₃ is cell1_fast_match signal 61₃ which is provided to gate 23₃, the output of timing register 22₄ is cell1_med_match signal 61₄ which is provided to gate 23₄, and the output of timing register 22₅ is rds_match 61₅ which is provided to gate 23₅. The output of each of the gates 23 is provided as input to OR gate 24. Based at least in part on match signals 49 provided by RDS controller 12 and the match control signals, data from the appropriate staging register 26₁, 26₂, 26₄, 26₅, and 26₇ may be provided to BIB 21 via priority multiplexer 25.

Data from the data pads is staged in different registers 26 and on each clock cycle RDS controller 12 determines which staging register should provide data to BIB 21. Thus, data from the appropriate data pad and with the appropriate latency, preferably minimum latency, may be provided to BIB 21 based on the signals received from RDS controller 12.

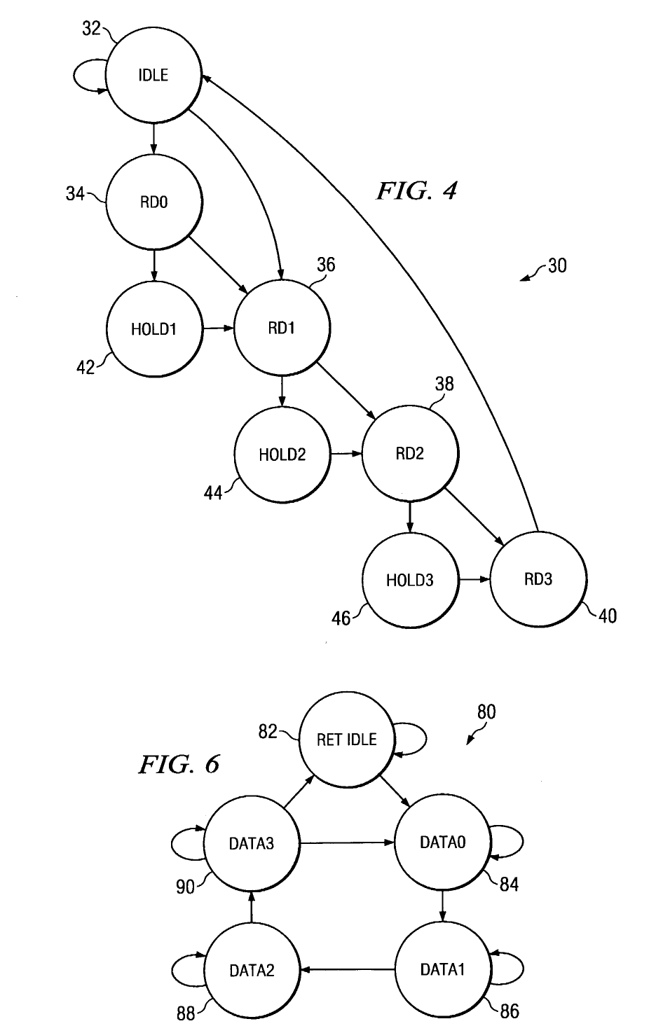

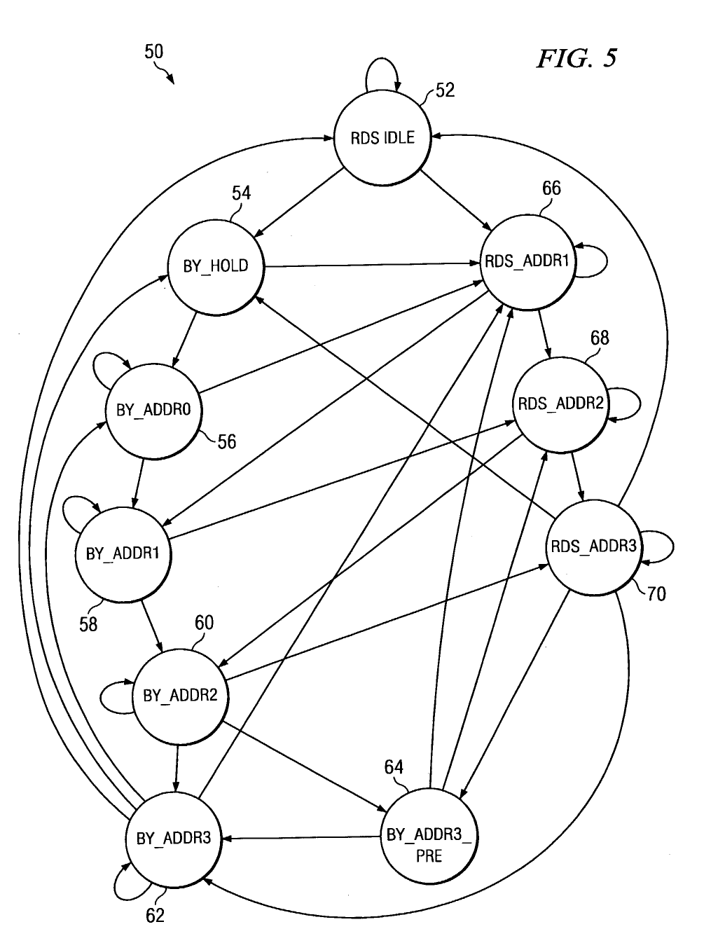

FIG. 4 is a state transition diagram for a Write Control Finite State Machine (WCFSM) 30 in accordance with an embodiment of the present invention, FIG. 5 is a state transition diagram for an Address Control and Bypass Finite State Machine (ACBFSM) 50 in accordance with an embodiment of the present invention, and FIG. 6 is a state transition diagram for a Data Advance Finite State Machine (DAFSM) 80 in accordance with an embodiment of the present invention. Preferably, WCFSM 30, ACBFSM 50 and DAFSM 80 comprise logic that facilitates RDS controller 12 in selecting data received from multiple data pads for routing to the BIB.

Preferably, RDS controller 12 comprises multiple instances of WCFSM 30, one for each input data pad. WCFSM 30 has a plurality of states—an idle state 32, a plurality of read data states 34, 36, 38, and 40, and a plurality of hold states 42, 44, and 46. The number of read data states preferably depends on the minimum number of clock cycles required to transmit a cache line. In an exemplary embodiment, cache lines that are 128 bytes long are used with ¼ cache line being transmitted to the requesting device per bus clock.

WCFSM 30 coordinates writing of the data into the correct location of storage array 14 for later reading by ACBFSM 50. Individual words of data may be separated by one or more clocks in the input data stream. Therefore, one or more hold states 42, 44, 46 are provided in the state machine. WCFSM 30 updates the data valid vector when it has completed writing each word of a cache line to help ACBFSM 50 determine which of the possible return paths has a valid data word on each clock. WCFSM 30 communicates the current state of each location in storage array 14 to ACBFSM 50 via the data valid vector.

Initially, WCFSM 30 waits in idle state 32. The primary triggers for WCFSM 30 are store read data signals 33 received from memory controller 17. Upon receipt of store read data signals 33, the state may change to read data state 34 or read data state 36. Preferably, on exiting Idle state 32 and/or each of the read data states 34, 36, 38 and 40, data is written into storage array 14. However, there may be some cases where it is desirable to wait for succeeding words before writing the received words to storage array 14. As such, hold states 42, 44, and 46 are provided to enable waiting for succeeding words in intervening clocks.

WCFSM 30 operates in the memory clock domain and generates its output signals in that domain. ACBFSM 50 and DAFSM 80 sample the signals from WCFSM 30 into the BIB clock domain and operate in that domain to efficiently transfer data to BIB 21.

ACBFSM 50 (FIG. 5) controls the flow of the data words through RDS 10 and the various data return paths. It identifies where the current data word is valid and determines the best available return path for returning the data to the BIB. ACBFSM 50 can process multiple data requests from BIB 21 at the same time. ACBFSM 50 pipelines the data for minimum latency return. As such ACBFSM 50 can maintain a sustained stream of back-to-back data returns through the various return paths. ACBFSM 50 generates the address within storage array 14 from which the data to be returned to BIB 21 is to be read.

ACBFSM 50 has a plurality of states—an RDS idle state 52, a hold state 54, a plurality of bypass address states 56, 58, 60, and 62, a precharge state 64, and a plurality of storage array address states 66, 68 and 70. The number of storage array address states 66, 68, and 70 and bypass address states 56, 58, 60 and 62 preferably depends on the minimum number of clock cycles required to transmit a cache line.

In RDS idle state 52, BIB 21 is not ready to receive the data. Storage array address state 66 indicates that the first data word of the cache line is returned to BIB 21 from storage array 14, storage array address state 68 indicates that the second word of the cache line is returned to BIB 21 from storage array 14, and so on.

Hold state 54 is a staging state which is preferably used when a determination is made that a bypass path may be taken and/or when there is a desire to transition into reading another location in storage array 14.

The primary trigger for ACBFSM 50 are trigger signal 45 from BIB 21, which indicates that the BIB is ready to receive data; data valid vector, which helps ACBFSM 50 determine the current position of the data word in the available data return paths, which may be storage array 14 or one of the bypass paths; and a data advance signal from BIB 21 which indicates when the BIB has accepted a specific data word.

The interconnection between the storage array address states 66, 68 and 70 and the bypass address states 56, 58, 60 and 62 enables each data word of a cache line to take the data path that has optimal latency for that data word without regard to the path taken by a previous or succeeding data word. For example, a first data word may be returned to BIB 21 via a bypass path, a second data word may be returned to BIB 21 from storage array 14, a third data word may be returned to BIB 21 from a different location in storage array 14 and a fourth data word may be returned to BIB 21 via a different bypass path. By not requiring the various data words of a cache line to take the same path, latency in returning the data to the BIB is reduced.

From bypass address state 60, a transition may be made to bypass address state 62 or to precharge state 64. This configuration enables transitioning between successive cache lines without having an idle cycle. Thus, the interconnections between bypass address state 60, bypass address state 62 and precharge state 64 enable succeeding cache lines to be transferred without an intervening idle state 52. Because there is a possibility of latency between successive cache lines, during precharge state 64 data for the next cache line is prepared so that there is no latency between two successive cache lines. In bypass address state 62, RDS controller 12 is: i) preparing to send the final data word of the current cache line through one of the plurality of bypass paths, ii) preparing to transition the first word of the next cache line through one of the plurality of bypass paths, and iii) preparing to return to RDS idle state 52.

DAFSM 80 monitors data exchange between RDS 10 and BIB 21. It tracks which data word BIB 21 has received and notifies ACBFSM 50 when to advance to the next data word in the current cache line. The principal trigger for DAFSM 80 is signal 45, which indicates to DAFSM 80 that the BIB is ready to receive data.

DAFSM 80 has a plurality of states—a return idle state 82 and a plurality of data states 84, 86, 88, and 90. Return idle state 82 indicates that BIB 21 is not ready to receive the data. Preferably, there is one data state for each data word of a full cache line and DAFSM 80 stays in a particular data state until the data word corresponding to that data state has been transferred at which point DAFSM 80 moves to the next data state. In the illustrated embodiment of FIG. 6, in data state 84, the transfer of data word 0 is monitored. Once data word 0 has been transferred, in data state 86, the transfer of data word 1 is monitored. Once data word 1 has been transferred, in data state 88, the transfer of data word 2 is monitored and once data word 2 has been transferred, in data state 90, the transfer of data word 3 is monitored.

DAFSM 80 generates the address used in comparison to create matches for the various possible data sources. DAFSM 80 monitors match signals 49 and compares the generated address with match signals 49 to make a determination about the data words that have been transferred to the BIB. Once a data word has been transferred to the BIB, DAFSM 80 generates the data advance signal to advance to the next data word.

Although, the exemplary embodiment of the present invention has been described herein with respect to two sets of memory modules 15A and 15B, the invention is not so limited. If desired, a single or more than two sets of memory modules may be used without departing from the scope of the present invention.

A technical advantage of an exemplary embodiment of the present invention is that it improves memory read latency. Another technical advantage of an exemplary embodiment of the present invention is that it synchronizes data returns across clock boundaries. Another technical advantage of an exemplary embodiment of the present invention is that it supports multiple data return paths. Another technical advantage of an exemplary embodiment of the present invention is that it supports returning read data without regard to the order in which read transactions are issued to the memory controller.

What is claimed is:

1. A system for returning data, comprising:
a storage array operable to store data received from at least one data source;
a bypass circuit communicatively coupled with said storage array and operable to simultaneously stage data received from said at least one data source; and
a read data storage (RDS) controller communicatively coupled with said storage array and said bypass circuit and operable to select a data return path of minimum latency from a plurality of data return paths for returning data selected from one of said storage array and said bypass circuit, based at least in part on at least one tag associated with each of said at least one data source, to a requesting device.

2. The system of claim 1, wherein at least one tag relates to data requested by said requesting device and comprises an address and a critical word received from a Bus Interface Block (BIB).

3. The system of claim 1, wherein at least one tag is associated with data received from said at least one data source and comprises a memory data tag signal associated with one of said at least one data source and a controller critical word.

4. The system of claim 1, further comprising a critical word multiplexer operable to receive said data from said at least one data source and format said data into a format requested by said requesting device.

5. The system of claim 4, wherein said critical word multiplexer is operable to provide formatted data to at least one of said storage array and said bypass circuit.

6. The system of claim 1, wherein said storage array comprises a plurality of storage cells of equal width.

7. The system of claim 1, wherein said bypass circuit comprises a plurality of staging areas, each of said plurality of staging areas operable to stage data prior to the data being provided to said requesting device.

8. The system of claim 1, wherein said RDS controller comprises at least one finite state machine operable to determine based at least in part on said at least one tag whether to provide data to said requesting device from said storage array or from said bypass circuit.

9. The system of claim 1, wherein said RDS controller comprises at least one finite state machine operable to write data from said at least one data source into a correct location of said storage array.

10. The system of claim 9, wherein said at least one finite state machine is further operable to update a data valid vector of said RDS controller upon completion of a write operation to facilitate determination of said data return path of said plurality of data return paths.

11. The system of claim 1, wherein said RDS controller comprises at least one finite state machine operable to determine a location in said storage array from which to return data to said requesting device.

12. The system of claim 11, wherein said at least one finite state machine is further operable to determine said data return path of minimum latency.

13. The system of claim 1, wherein said RDS controller comprises a finite state machine operable to notify another finite state machine to advance a data word in a current cache line to said requesting device.

14. The system of claim 1, wherein said bypass circuit comprises at least one staging register operable to receive data from a critical word multiplexer.

15. The system of claim 1, wherein said bypass circuit comprises at least one staging register operable to receive data from said storage array.

16. The system of claim 1, wherein said at least one data source comprises a memory module.

17. A method for returning data, comprising:
receiving a request for data from a requesting device;
receiving data from at least one data source;
storing said received data in a storage array;
simultaneously staging said received data in a bypass circuit;
selecting a data return path of minimum latency from a plurality of data return paths for returning said data; and
providing data from one of said storage array and said bypass circuit to said requesting device via said selected data return path of minimum latency based at least in part on at least one tag associated with each of said at least one data source.

18. The method of claim 17, further comprising associating at least one tag with data requested by said requesting device, said at least one tag comprising an address and a critical word received from a Bus Interface Block (BIB).

19. The method of claim 17, further comprising associating at least one tag with data received from said at least one data source, said at least one tag comprising a memory data tag signal associated with one of said at least one data source and a controller critical word.

20. The method of claim 17, further comprising formatting said data into a format requested by said requesting device prior to said providing step.

21. The method of claim 17, further comprising determining based at least in part on said at least one tag whether to provide data to said requesting device from said storage array or from said bypass circuit.

22. The method of claim 17, further comprising writing data from said at least one data source into a correct location of said storage array.

23. The method of claim 17, further comprising updating a data valid vector upon completion of a write operation to facilitate selection of said data return path of said plurality of data return paths.

24. The method of claim 17, further comprising determining a location in said storage array from which to return data to said requesting device.

25. A system for returning data, comprising:
means for storing said data received from at least one data source;
means for simultaneously staging said data received from said at least one data source;
means for selecting a data return path of minimum latency from a plurality of data return paths for returning said data; and
means for providing data to a requesting device from one of said means for storing and said means for simultaneously staging, via said selected data return path of minimum latency based at least in part on at least one tag associated with each of said at least one data source.

26. The system of claim 25, further comprising means for receiving a request for said data.

27. The system of claim 25, further comprising means for receiving data from at least one data source.

28. The system of claim 25, wherein said means for storing comprises a storage array.

29. The system of claim 25, wherein said means for simultaneously staging comprises a bypass circuit.

30. The system of claim 25, further comprising means for associating at least one tag with data requested by said requesting device, said at least one tag comprising an address and a critical word received from a Bus Interface Block (BIB).

31. The system of claim 25, further comprising means for associating at least one tag with data received from said at least one data source, said at least one tag comprising a memory data tag signal associated with one of said at least one data source and a controller critical word.
